(19) United States
(12) Patent Application Publication
(10) Pub. No.: US 2003/0026674 A1
(43) Pub. Date: Feb. 6, 2003

(54) Fastener retainer assembly

(76) Inventor: Shankar Hegde, Annassandrapalya Bangalore (IN)

Correspondence Address: HEWLETT-PACKARD COMPANY, Intellectual Property Administration, P.O. Box 272400, Fort Collins, CO, 80527-2400, US

(21) Appl. No.: 09/920,424

(22) Filed: Jul. 31, 2001

(51) Int. Cl. F16B 21/18

(52) U.S. Cl. 411/353

(57) ABSTRACT

A retainer assembly for retaining a fastener that includes a shank having a recessed portion therein is disclosed. The retainer assembly includes an inner wall that is inset from and outer wall and is symmetrically positioned about an axis defining a chamber through the retainer body. The chamber includes opposed entrance and exit apertures. The inside wall includes a first inside diameter that extends from the entrance aperture in a direction along the axis and narrowing to a second inside diameter at a slip-over profile, and the inner wall narrowing again to a third inside diameter at an annular ring that extends to the exit aperture. The fastener is inserted through the entrance aperture until the shank engages and then slips over the slip-over profile and through the annular ring so that the recessed portion of the shank is captured within the annular ring.

### FIELD OF THE INVENTION

The present invention relates generally to a fastener retainer assembly that is adaptable to a number of applications that use fasteners. More specifically, the present invention relates to a fastener retainer assembly that can retain a fastener and optionally a spring to a base plate of a cooling device such as a heat sink.

### BACKGROUND ART

Current methods for retaining a fastener in a through hole includes the use of a circlip. The circlip is a c-shape fastener that fits within a groove machined into a shank of the fastener, such as a screw for example. In FIGS. 1a through 1c, one example of a prior fastener 110 and a prior circlip 130 are illustrated. The fastener 110 includes a head portion 111 for receiving a tool used to screw or unscrew the fastener 110, a shank 113, a groove 115 formed in the shank 113, and a threaded portion 117 for insertion into a hole having screw threads therein. Typically, the groove 115 is machined with a high tolerance into the shank 113. Similarly the circlip 130 is also machined with a high tolerance so that a thickness t_{C} of the circlip 130 fits within a height h_{G} of the groove 115 so that the circlip 130 can be inserted (dashed arrow i) into the groove 115. Additionally, an inside diameter d_{I} of the circlip 130 must be precision machined to fit over an outside diameter d_{O} (see FIG. 1c) of the groove 115. When the fastener 110 is inserted through a hole (not shown) adapted to receive the fastener 110, the circlip 130 is inserted (see FIG. 1b) into the groove 115 so that the fastener 110 is retained in the hole because an outside diameter D_{O} of the circlip 130 is wider than an inside diameter of the hole the fastener 110 was inserted in; therefore, the fastener 110 cannot be pulled out of the hole unless the circlip 130 is removed.

There are some disadvantages to using a circlip such as the prior circlip 130 as a fastener retainer. First, because both the fastener 110 and the circlip 130 are parts that are precision machined to high tolerances and specifications, those parts cost more than if they were not precision machined. Second, to insert or remove the circlip 130 requires special tools. Therefore, manufacturing time and costs to assemble or disassemble the circlip 130 and fastener 110 are higher. Third, the circlip 130 is a specialized fastener component that is usually procured from an external supplier and adequate quantities must be held in inventory to ensure a ready supply. Accordingly, there is an inventory cost associated with maintaining that ready supply. Fourth, because of the high manufacturing tolerances of the circlip 130 and the fastener 110, a need to change the dimensions of the fastener 110 requires a change in the dimensions of the circlip 130. Therefore, those high tolerances preclude fastener design changes that may be necessary.

A prior use for a fastener and a circlip to retain the fastener is illustrated in FIG. 2 where a heat sink 100 having a plurality of cooling fins 101 is connected with a base plate 103 having an upper surface 104a and a lower surface 104b. The base plate 103 includes through holes 105 extending between the upper and lower surfaces (104a, 104b). Fasteners 120 are inserted into the through holes 105. The fasteners 120 include the aforementioned head portion 111, the shank 113, the groove 115, and the threaded portion 117. Additionally, the fasteners 120 are retained in the through holes 105 by circlips 130. The circlips 130 prevent removal of the fasteners 120 from the through holes in a direction indicated by arrow 102. Optionally, the fasteners 120 can include springs 119 that are fitted over their respective shanks 113 prior to insertion in the through holes 105. The clips 130 retain the fasteners 120 and the springs 119 to the base plate 103.

Typically, a component to be cooled (not shown), such as a microprocessor, is in contact with the lower surface 104b and waste heat generated by operation of the component is thermally transferred into the heat sink 100 were the heat is dissipated by a fan (not shown) that forces an air flow through the fins 101. The component is usually mounted to a PC board (not shown) and the threaded portion 117 of the fasteners 120 are screwed into threaded holes provided on the PC board so that the base plate 103 is mounted to the PC board and in contact with the component. As the fasteners 120 are screwed into the PC board, the springs 119 compress and urge the lower surface into snug contact with the component thereby lowering thermal resistance between the component and the base plate 103.

As mentioned previously, one disadvantage to using circlips 130 to retain the fasteners 120 and springs 119 is that specialized tools are required to insert or remove the circlips 130. For instance, specialized circlip pliers are needed to insert or remove the circlips 130 and those pliers increase assembly/disassembly time.

Another disadvantage is that after the base plate 103 is mounted to the PC board, an electrical short can occur if the circlips 130 come in contact with electrical traces on the PC board because the circlips 130 are typically made from an electrically conductive material, such as a metal, for example. In some applications, keep out zones are defined around an area to be occupied by the circlips 130 so that the electrical traces will be routed around the keep out zones to prevent the electrical traces from shorting with the circlips 130. In a densely routed PC board, those keep out zones can complicate routing of the electrical traces.

Finally, in some applications, the fasteners 120, the springs 119, and the circlips 130 used for connecting the base plate 103, are shipped separately to an end user, such as a customer, for example. The customer must then assemble the fasteners 120, the springs 119, and the circlips 130 to the base plate 103. The disadvantages of having the customer perform those tasks include increased assembly time and customer frustration that can arise due to difficulty in aligning the fasteners.

Consequently, there exists a need for a fastener retainer that does not require specialized tools to install or remove and that does not require the fastener or the retainer to be manufactured to high tolerances and specifications. Additionally, there is a need for a fastener retainer that will not cause an electrical short between electrical traces that come into contact with the fastener retainer. There also exists a need for a fastener retainer that reduces assembly time. There is a need for a fastener retainer that allows for flexibility in fastener selection so that design changes can be accommodated without redesigning the fastener retainer. Finally, there is a need for a fastener retainer that can be manufactured at low cost and has a low inventory cost.

### SUMMARY OF THE INVENTION

The present invention solves the aforementioned problems. The retainer assembly of the present invention does not require special tools for installation or removal thereby reducing assembly time. Moreover, the retainer assembly of the present invention can be made from a non-conductive plastic material that will not cause an electrical short circuit between electrical traces that come into contact with the retainer assembly. The plastic material allows for a low manufacturing and inventory costs. Additionally, the need for fasteners manufactured to high tolerances and specifications are eliminated by the retainer assembly because slight variations in fastener tolerances will not prevent retention of the fastener in the retainer assembly. Consequently, the retainer assembly allows for flexibility in fastener selection and can accommodate design changes. The retainer assembly allows for the fasteners and springs used with the base plate of a heat sink to be preassembled on the base plate prior to shipment to an end user. As a result, the end user is not burdened with additional assembly time and the frustrations that can result from trying to properly align all the fasteners.

Broadly, the present invention is embodied in a retainer assembly for retaining a fastener having a recessed portion formed in a shank of the fastener. A retainer assembly according to the present invention includes a retainer body having an outer wall with an outside diameter and an inner wall inset from the outer wall. The inner wall is symmetrically positioned about an axis and defines a chamber that extends through the retainer body. The chamber has opposed entrance and exit apertures and the inner wall includes a first inside diameter that extends inward of the entrance aperture in a direction along the axis. The first inside diameter then narrows to a second inside diameter at a slip-over profile. The second inside diameter then narrows to a third inside diameter at an annular ring that extends to the exit aperture. The fastener is inserted through the entrance aperture until the shank engages and then slips over the slip over profile and through the annular ring so that the recessed portion of the shank is captured within the annular ring and the fastener is retained in the chamber of the retainer assembly.

The retainer body can be inserted into a hole formed in a surface and having an inside diameter that is greater than the outside diameter of the outer wall. After insertion, the fastener can be inserted into the retainer assembly as described above and is retained in the retainer assembly when the recessed portion is captured within the annular ring. The portion of the shank that slipped over the slip-over profile will protrude from the exit aperture and if that portion included threads, then the fastener can be screwed into a threaded hole or the like. No special tools are required to insert the fastener into the retainer assembly.

In one embodiment of the present invention the retainer assembly includes a flange that is connected with the outer wall and extends outward of the outer wall. The flange prevents complete insertion of the retainer body into a bore (i.e. a hole).

In another embodiment of the present invention, the outer wall includes two or more ribs that are connected with the outer wall and extend outward of the outer wall. The ribs deform (i.e. they crush or partially collapse) when the retainer body is inserted into a bore. The ribs assist in centering the retainer body in the bore.

In yet another embodiment of the present invention, the retainer assembly includes at least two retainer bodies and a spanner connects the bodies and spatially positions the retainer bodies relative to each other.

In one embodiment of the present invention, the retainer body is made from an electrically non-conductive material.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIGS. 1a through 1c depict a prior fastener and a circlip for retaining the fastener.

FIG. 2 is a cross-sectional view of a prior fastener and spring retained by a circlip in a base plate of a heat sink.

FIGS. 3a through 3c are cross-sectional, top, and bottom views of a retainer assembly according to the present invention.

FIGS. 4a through 4c are cross-sectional, top, and bottom views of a retainer assembly including a flange and ribs according to the present invention.

FIG. 5 is a cross-sectional view depicting in greater detail of a portion of the retainer assembly of FIG. 4a below line A-A.

FIG. 6 is a cross-sectional view of the retainer assembly of FIG. 4a inserted in a bore according to the present invention.

FIG. 7 is a cross-sectional view of a plurality of a retainer assembly including a plurality of retainer bodies connected to each other by a spanner according to the present invention.

FIGS. 8a and 8c are top, bottom, and profile views respectively of the retainer assembly of FIG. 7.

FIGS. 9a and 9b are schematic views of an example of a fastener and a spring respectively that can be retained by a retainer assembly according to the present invention.

FIG. 10 is a cross-sectional view depicting insertion of a fastener into a retainer assembly according to the present invention.

FIG. 11 is a cross-sectional view depicting a fastener that has been fully inserted and captured within a retainer assembly according to the present invention.

FIG. 12 is a cross-sectional view depicting insertion of a plurality of fasteners into retainer bodies connected with a spanner according to the present invention.

FIG. 13 is a top profile view illustrating a retainer assembly and fasteners prior to insertion into a base plate according to the present invention.

FIG. 14 is a bottom profile view illustrating the base plate of FIG. 13 after insertion of the retainer assembly and fasteners according to the present invention.

FIG. 15 is an illustration of a heat sink and fan mounted to the base plate of FIG. 14.

FIG. 16 is a schematic view of a base plate adapted to receive a retainer assembly according to the present invention.

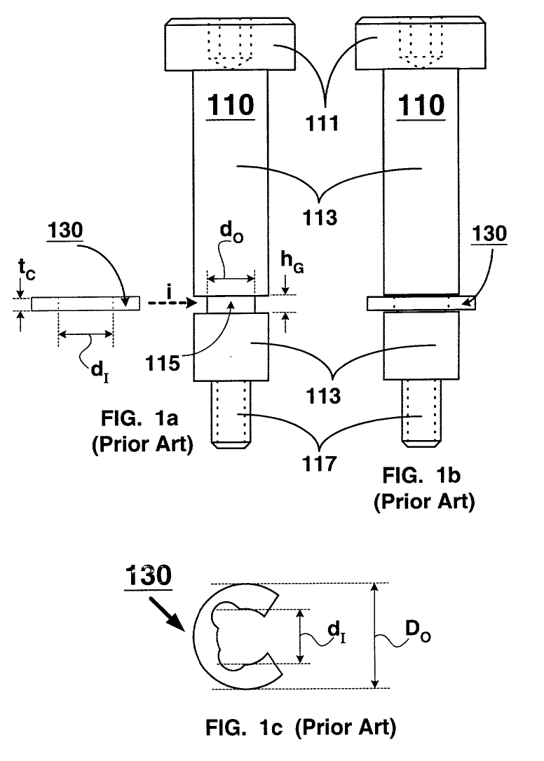

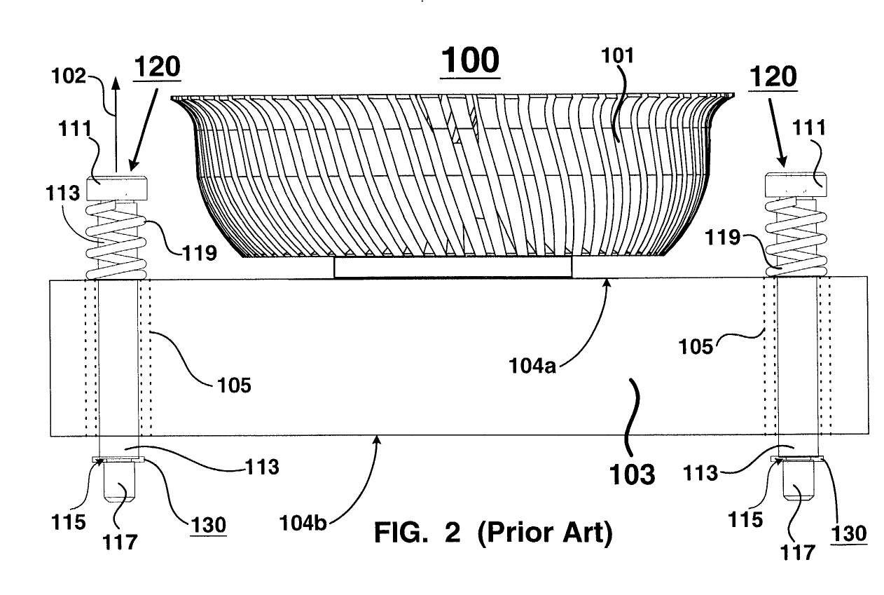

### DETAILED DESCRIPTION

In the following detailed description and in the several figures of the drawings, like elements are identified with like reference numerals.

As shown in the drawings for purpose of illustration, the present invention is embodied in a retainer assembly for retaining a fastener that includes a shank having a recessed portion therein. The retainer assembly includes at least one retainer body having an outer wall with an outer diameter and an inner wall that is inset from the outer wall and is symmetrically positioned about an axis thereby defining a chamber through the retainer body. The chamber includes an entrance aperture that is positioned opposite an exit aperture. The inside wall includes a first inside diameter that extends from the entrance aperture in a direction along the axis and narrowing to a second inside diameter at a slip-over profile, and the inner wall narrowing again to a third inside diameter at an annular ring that extends to the exit aperture. Therefore, the inner wall includes in order of decreasing inside diameter, the first, second, and third inside diameters. The fastener is inserted through the entrance aperture until the shank engages and then slips over the slip-over profile and through the annular ring so that the recessed portion of the shank is captured within the annular ring.

The retainer body is made from a material that can deform slightly at the slipover profile in response to the shank passing through the chamber. The shank has an outside diameter that is greater than the third inside diameter at the annular ring but is only slightly greater than the second inside diameter at the slip over profile. As a result, the shank can slip past the slip-over profile and through the annular ring as the retainer body deforms, but after the shank has passed through the annular ring and out of the exit aperture, the recessed portion is captured within the annular ring because the recessed portion has an outside diameter that is less than the third inside diameter. Due to the larger outside diameter of the shank, the retainer body will not deform to allow the shank to pulled back through the annular ring.

The retainer assembly can be made from an electrically non-conductive material so that the retainer assembly will not cause a short circuit if it comes into contact with electrically conductive traces.

The use of plastic for the retainer assembly also allows for low manufacturing and inventory costs and allows for variations in fastener dimensions without having to resort to the use of a different retainer assembly for minor variations in fastener dimensions.

A fastener can be inserted and removed from the retainer assembly without the need for special tools and insertion and removal can be done quickly thereby reducing assembly and disassembly time.

The retainer assembly positions an inserted fastener on axis so that the fastener is substantially in alignment with a threaded hole or the like for receiving a threaded portion of the fastener.

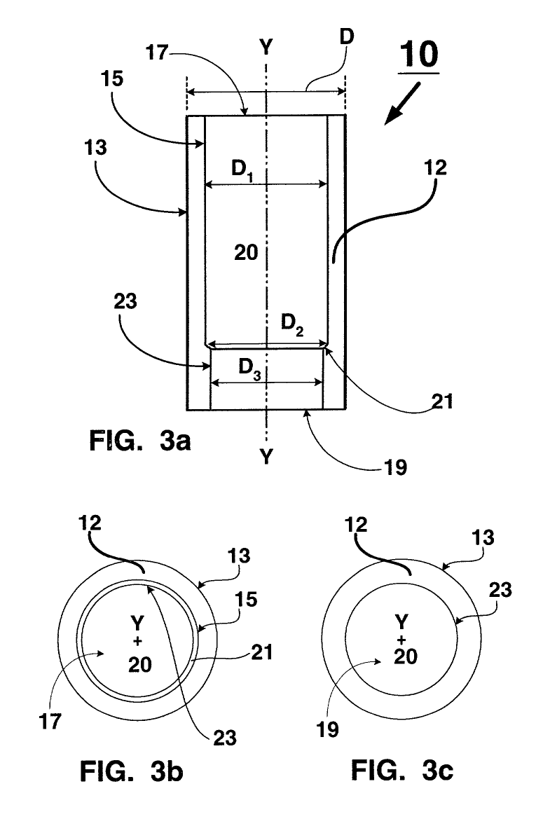

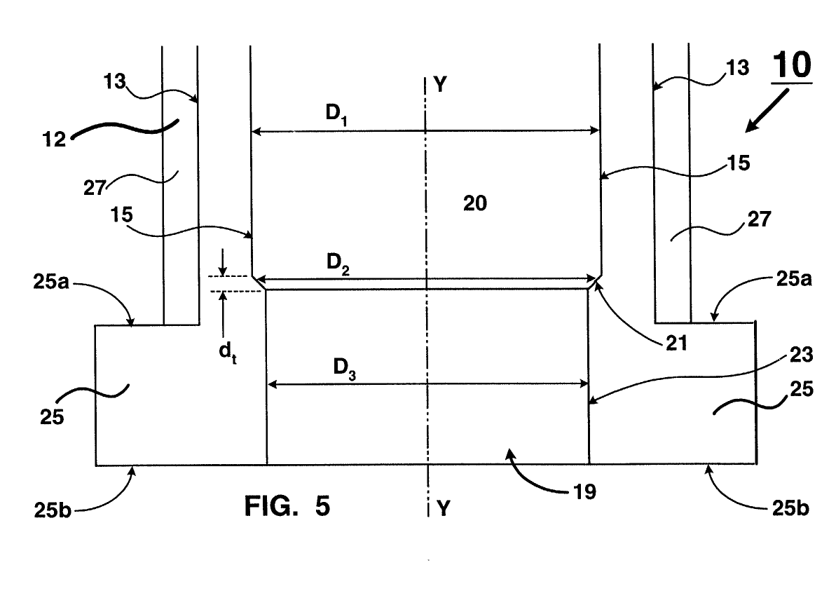

In FIG. 3a, a retainer assembly 10 includes a retainer body 12 that includes an outer wall 13 having an outside diameter D and an inner wall 15 that is inset from the outer wall 13. The inner wall 15 is symmetrically positioned about an axis Y-Y and defines a chamber 20 having an entrance aperture 17 and an exit aperture 19. Along the axis Y-Y in a direction from the entrance aperture 17 to the exit aperture 19, the inner wall 15 narrows in inside diameter as follows. The inner wall 15 includes a first inside diameter D₁ that extends from the entrance aperture 17 and then narrows to a second inside diameter D₂ at a slip-over profile 21 and then narrows again to a third inside diameter D₃ at an annular ring 23 (D₃<D₂<D₁). The annular ring 23 extends to the exit aperture 19. The slip-over profile 21 can have an sloped profile (see FIG. 5) or a concave arcuate profile. The sloped or arcuate profile allows for a gradual transition over a short distance dₜ from the first inside diameter D₁ to the third inside diameter D₃. Essentially, the second inside diameter D₂ at the slip-over profile 21 is not a substantially constant inside diameter due to the profile of the slip-over profile 21 so that the second inside diameter D₂ decreases slightly in inside diameter along a surface of the profile until it blends with the third inside diameter D₃ at the annular ring 23. Preferably, the slip-over profile 21 has a sloped profile.

FIGS. 3b and 3c are top and bottom views respectively of the retainer assembly 10. FIG. 3b, illustrates a view that is into the chamber 20 from the entrance aperture 17 and FIG. 3c illustrates a view that is into the chamber 20 from the exit aperture 19. It should be noted that in FIGS. 3b and 3c, the inside diameter of the entrance aperture 17 is greater than the inside diameter of the exit aperture 19.

The retainer assembly 10 can be made from a variety of materials including metals, elastomers, rubber, and plastics. The choice of material will be application dependent. For instance, for electrical applications it may be desirable to use plastic or rubber because plastic and rubber are generally electrically non-conductive materials. In one embodiment of the present invention, the retainer body 12 is made from an electrically non-conductive material. The electrically non-conductive material can include but is not limited to a glass filled polycarbonate. An exemplary electrically non-conductive material is 30% glass filled polycarbonate.

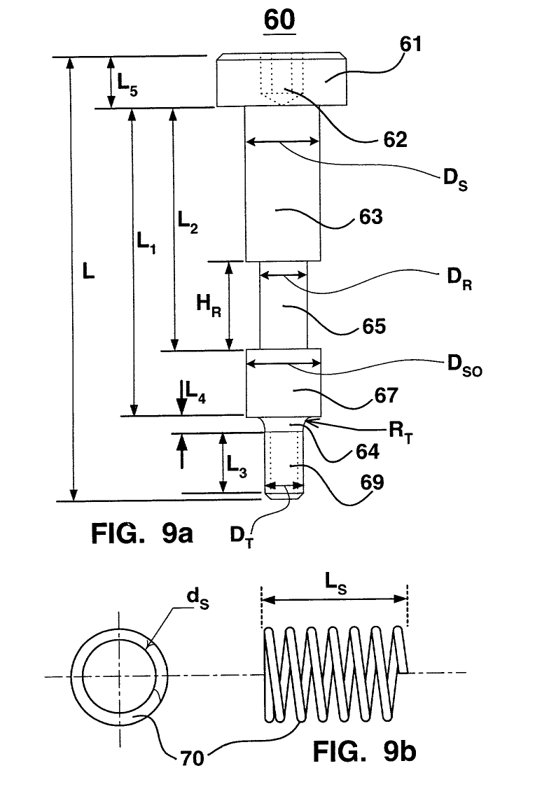

In FIG. 9a, a fastener 60 includes a head 61 having a slot 62 adapted to be driven by a tool such as a screw driver, a hex driver, or the like. The fastener 60 further includes a shank 63 having an outside diameter D_{S}, a recessed portion 65 having an outside diameter D_{R}, a shank 67 having an outside diameter D_{SO}, and a threaded portion 69 having an outside diameter D_{T}. The outside diameters (D_{S}, D_{SO}) of the shanks (63, 67) can be identical (D_{S}=D_{SO}) or the outside diameter D_{SO} of shank 67 can be less than the outside diameter D_{S} of the shank 63 (D_{SO}<D_{S}). The outside diameter D_{T} of the threaded portion 69 is less than the outside diameter D_{SO} of shank 67 (D_{T}<D_{SO}).

In FIG. 9b, a spring 70 that can optionally be used in conjunction with the fastener 60 and the retainer assembly 10 can have an inside diameter d_{S} that is larger than the outside diameters of either one of the shanks (63, 67). That is, the inside diameter d_{S}>D_{S} and d_{S}>D_{SO} so that the fastener 60 can be inserted into the spring 70.

When the fastener 60 is inserted through the entrance aperture 17 and into the chamber 20, the shank 67 engages the slip-over profile 21 and slips over the slip-over profile and through the annular ring 23 and out the exit aperture 19. The threaded portion 69 easily passes through the entirety of the chamber 20 and out the exit aperture 19 because its outside diameter D_{T} is less than the third inside diameter D₃. However, the recessed portion 65 is captured within the annular ring 23 because the outside diameter D_{S} of the shank 63 cannot pass through the slipover profile 21 and the outside diameter D_{SO} of shank 67 is greater than the third inside diameter D₃ of the annular ring 23 so the shank 67 cannot reenter the annular ring 23 through the exit aperture 19.

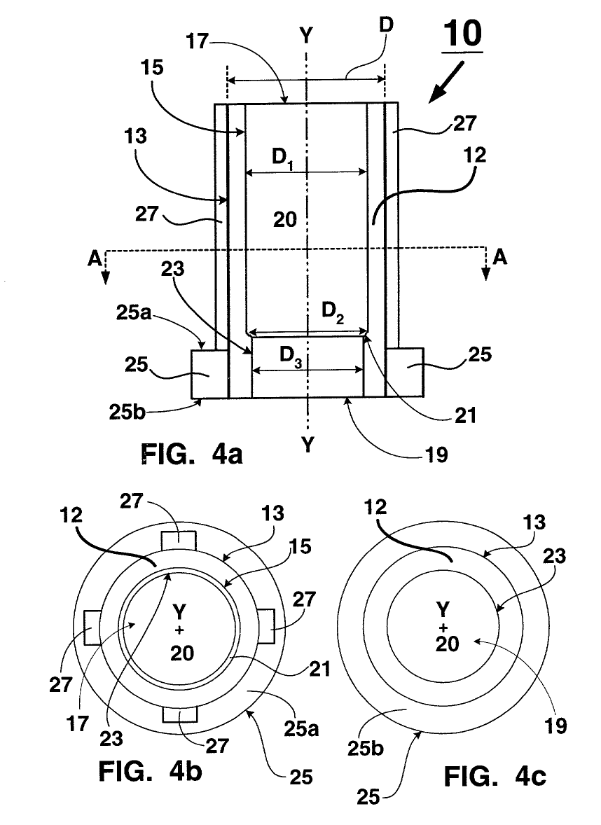

In one embodiment of the present invention as illustrated in FIGS. 4a through 4c and FIG. 5, the retainer assembly 10 includes a flange 25 connected with the outer wall 13 and extending outward of the outer wall 13. The flange 25 prevents complete insertion of the retainer body 12 into a bore (i.e. a hole) having a sufficient inside diameter to receive the retainer body 12. The flange 25 includes an upper surface 25a and a lower surface 25b.

In another embodiment of the present invention, also illustrated in FIGS. 4a through 4c and FIG. 5, the retainer assembly 10 includes a plurality of ribs 27 (four are shown) that are connected with the outer wall 13 and extend outward of the outer wall 13. The ribs 27 are designed to deform (i.e. they collapse/crush) upon insertion of the retainer body 12 into a bore a sufficient inside diameter to receive the retainer body 12. The ribs 27 also provide a tight fit between the bore and the retainer body 12 so that the retainer body 12 is retained (i.e is held) in the bore. Additionally, the ribs 27 operate to center the retainer body 12 within the bore. Preferably, the ribs 27 are equidistantly spaced apart from one another as illustrated in FIG. 4b. The ribs 27 can also have an orientation that is colinear (see FIGS. 4a and 4b) with the axis Y-Y.

FIG. 5 is an enlarged view of a section of the retainer assembly 10 of FIG. 4a taken along line A-A. In FIG. 5, the gradually decreasing inside diameter (D₃<D₂ <D₁) of the chamber 20 is shown in greater detail and the sloped profile of the slipover profile 21 illustrates that the second inside D₂ varies in inside diameter along a surface of that profile as D₂ narrows to a point where it blends with the third inside D₃.

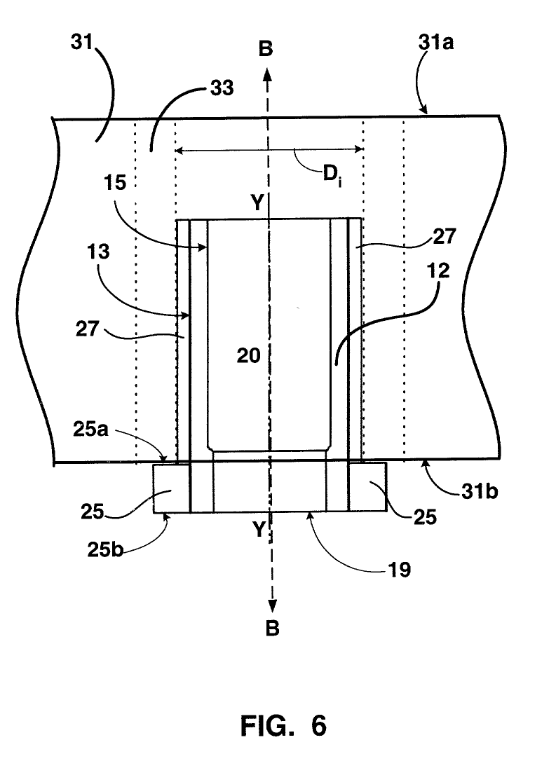

Turning now to FIG. 6, wherein, a object 31 has a through bore 33 (i.e. a through hole) formed therein and the retainer body 12 is inserted into the bore 33 with the upper surface 25a of the flange 25 preventing complete insertion of the retainer body 12 into the bore 33. The bore 33 has an inside diameter Dᵢ sufficient to allow insertion of the retainer body 12. A sufficient diameter includes one in which the total diameter of the retainer body 12 including the ribs 27 is greater than the inside diameter Dᵢ because the ribs 27 can collapse upon insertion into the bore 33. As was mentioned above, the ribs 27 aid in centering the retainer body 12 in the bore 33 so that the axis Y-Y is aligned with a bore central axis B-B. Another advantage to using the ribs 27 is that upon insertion into the bore 33, the ribs crush and retain the retainer body 12 in the bore 33.

The object 31 can be a surface or it can be a base plate for a heat sink. The retainer assembly 10 of the present invention can be used in a wide variety of applications in which it is necessary to retain a fastener. Accordingly, the retainer assembly 10 of the present invention is not to be construed as being limited to use with heat sinks.

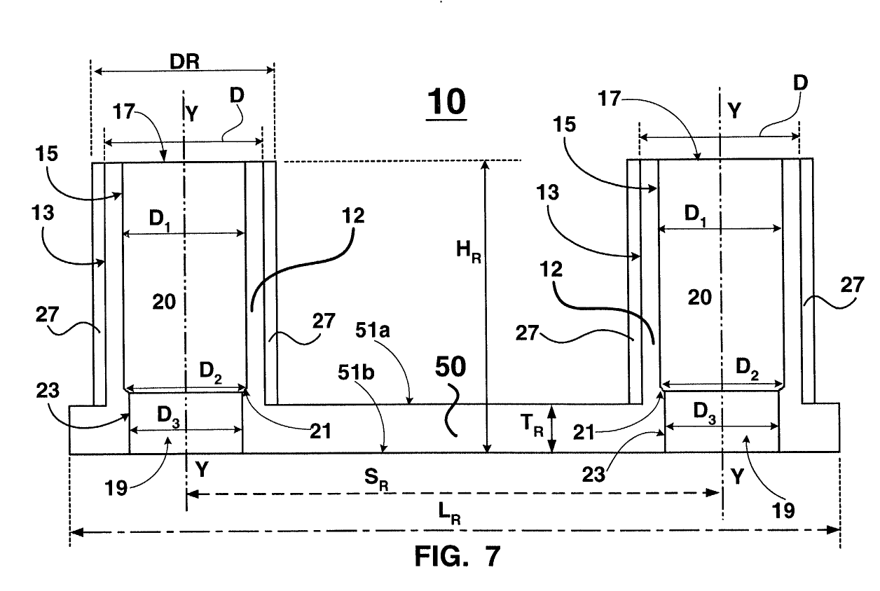

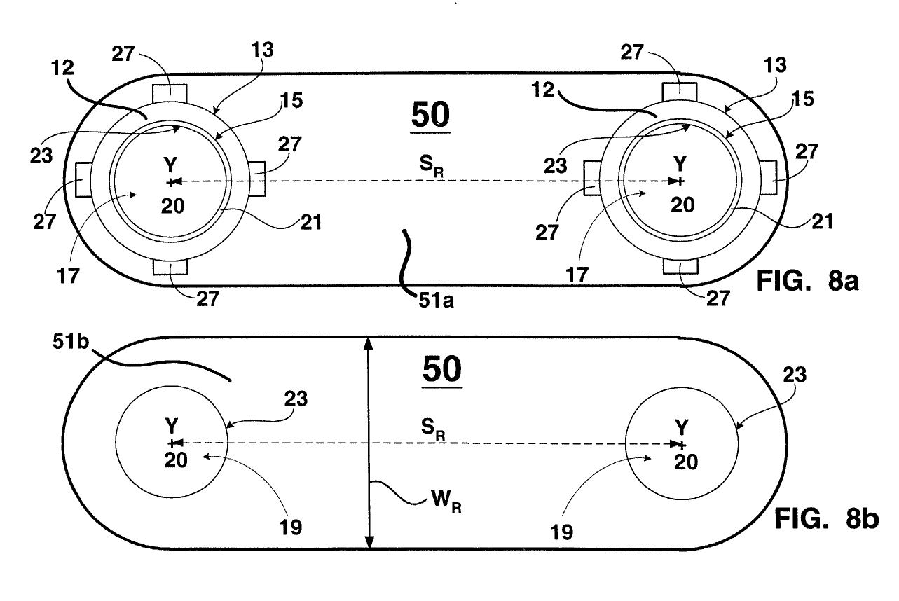

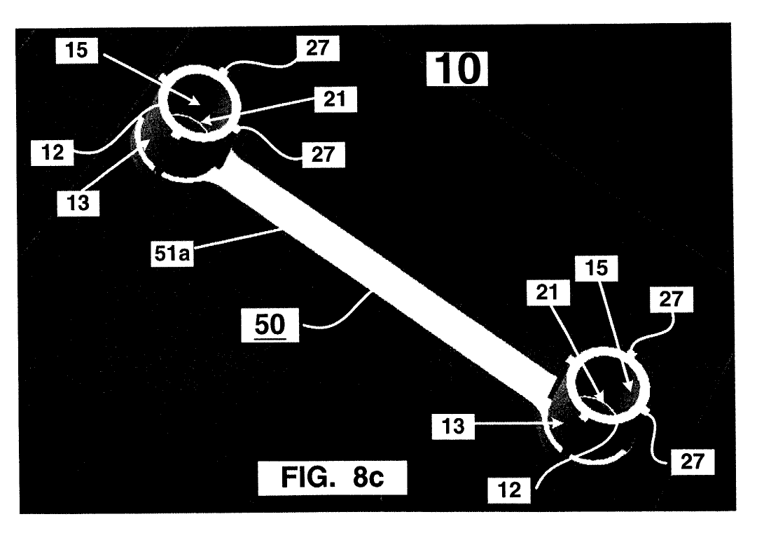

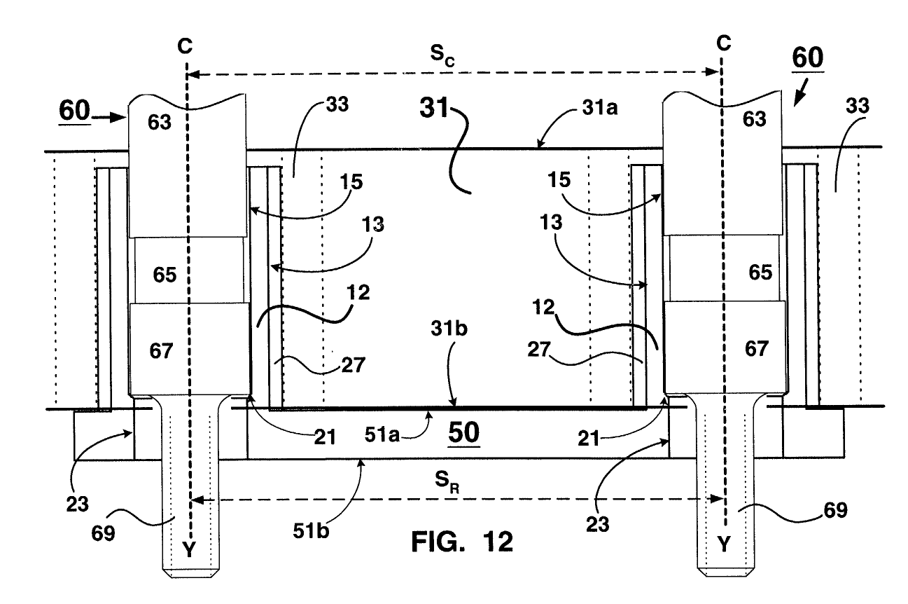

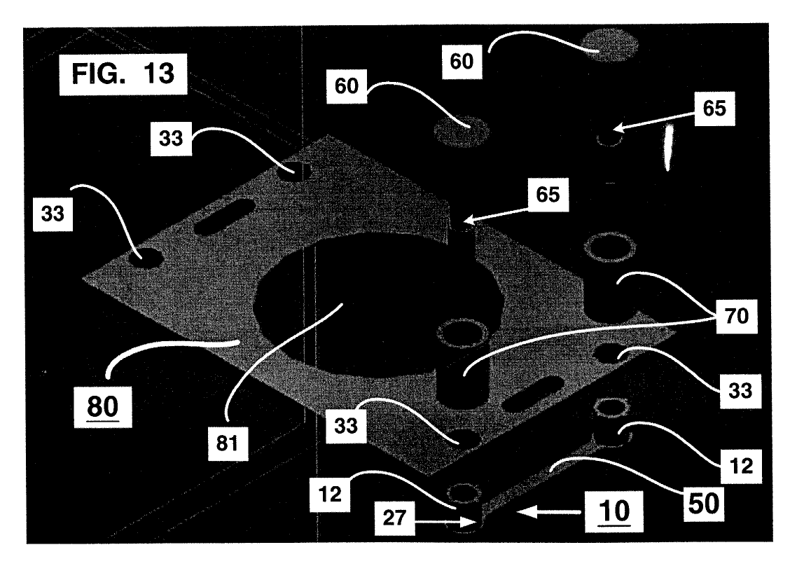

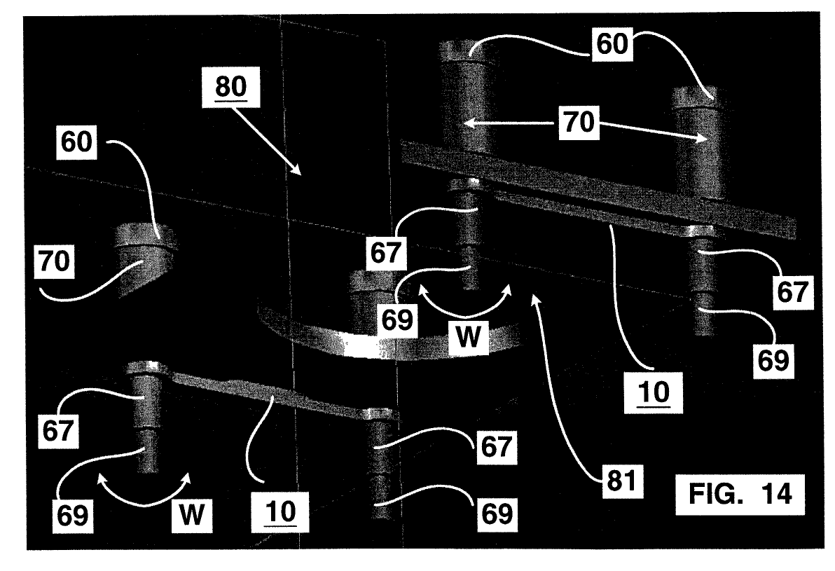

In one embodiment of the present invention as illustrated in FIGS. 7, and 8a through 8c, the retainer assembly 10 includes a spanner 50 that is connected with at least two retainer bodies 12. The spanner 50 includes an upper surface 51 a and a lower surface 51b. The upper surface 51 a can serve a purpose similar to that of the aforementioned flange 25 and its upper surface 25a by preventing complete insertion of the retainer bodies 12 into a bore (see FIG. 12). The spanner 50 spatially positions the retainer bodies 12 relative to each other. For instance, the spanner 50 can establish a predetermined distance S_{R} between the axes Y-Y of the retainer bodies 12 as illustrated in FIGS. 7, 8a, and 8b. The predetermined distance S_{R} can be selected to substantially match hole centers in bores the retainer bodies 12 will be inserted in.

Although FIGS. 7, and 8a through 8c illustrate only two retainer bodies 12, the spanner 50 can connect a plurality of the retainer bodies 12. The retainer bodies 12 need not be positioned in a substantially linear arrangement with each other on the spanner 50 and the retainer bodies 12 need not be positioned in a substantially planar relationship with each other on the spanner 50 as illustrated in FIGS. 7, and 8a through 8c. For instance, the spanner 50 can spatially position one of the retainer bodies 12 on plane that is higher or lower than that of other retainer bodies 12 that are also connected with the spanner 50. That arrangement can be useful for insertion of the retainer bodies 12 into bores that lie different planes. Preferably, spanner 50 positions the retainer bodies 12 so that they are in a substantially planar orientation with each other. The retainer bodies 12 can include the ribs 27 as described above.

Preferably, the spanner 50 and the retainer bodies 12 are made from the same material and that material can be the same as the material as set forth above. For electrical applications, the preferred material is a plastic such as the aforementioned electrically non-conductive materials such as glass filled polycarbonate and 30% glass filled polycarbonate.

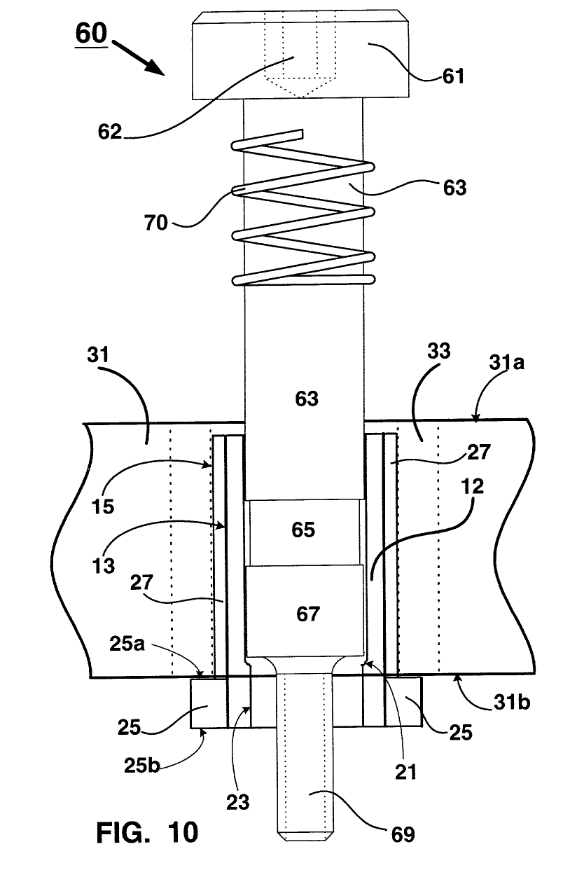

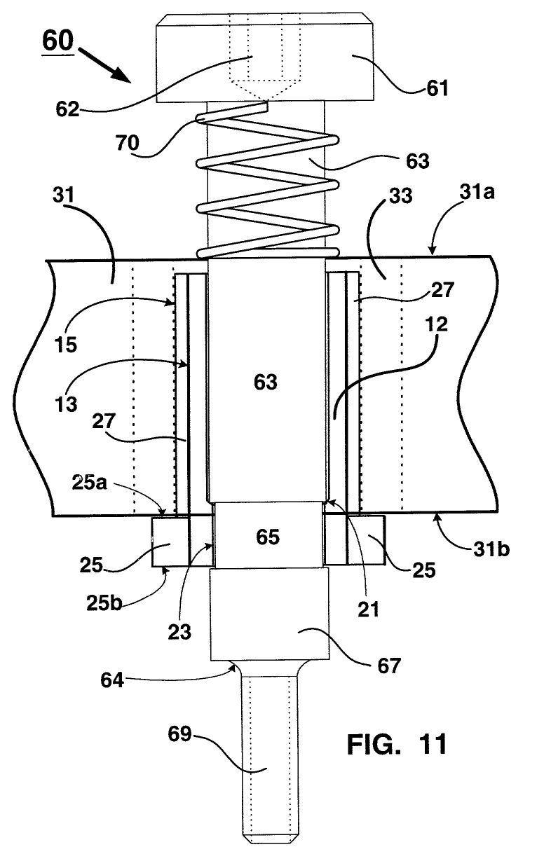

Now, for all the embodiments described herein, FIGS. 10, 11, and 12 illustrate the insertion and retention of the fastener 60 in the retainer assembly 10. In FIG. 10, the fastener 60 is depicted with the shank 67 already inserted in the chamber 20 and positioned proximate the slip-over profile 21. The threaded portion 69 is substantially outside the annular ring 23 due to the small outside diameter of the threaded portion 69 relative to the inside diameter D₃ of the annular ring 23. Prior to insertion of the fastener 60 into the chamber 20, a spring 70 may be fitted over the shank 63. The shank 67 is now urged into contact with the slip-over profile 21 so that the shank 67 slips past the slip-over profile 21 and into and through the annular ring 23 and out of the exit aperture 19 as depicted in FIG. 11. In FIG. 11, the outside diameter D_{S} of the shank 63 cannot slip past the slip-over profile 21. Similarly, the outside diameter D_{SO} of shank 67 will not allow the shank 67 to slip past the annular ring 23. As a result, the recessed portion is captured in the annular ring 23 and the fastener 60 is retained by the retainer assembly 10.

Depending on the dimensions of the fastener 60 and the retainer assembly 10, the spring 70 may be in a compressed state after insertion and retention of the fastener 60 in the retainer assembly 10. On the other hand, the spring 70 may not be in a compressed state after insertion and retention.

In FIG. 12, the spanner 50 is used to position the retainer bodies 12 so that their respective axes Y-Y substantially align with bore hole centers C-C of bores 33 that are formed in the object 31. For purposes of illustration only, the head portions 61 of the fasteners 60 have been omitted. The fasteners are depicted with their respective shanks 67 positioned proximate the slip-over profiles 21 of the retainer bodies 12. After complete insertion and retention, the configuration of FIG. 12 has the added benefit of maintaining the fasteners in alignment with the axis Y-Y so that the threaded portions 69 can be more easily aligned with threaded holes they are to be inserted in.

Therefore, the configuration illustrated in FIG. 12 is ideal for retaining fastener in a base plate of a heat sink because there are usually four fasteners used for mounting the base plate to a mother board. If the fasteners are allowed to move freely as in the case when the prior circlips are used to retain the fasteners, then it will be difficult to simultaneously align all four fasteners with their respective threaded holes. In contrast, the retainer assembly 10 of the present invention sufficiently restricts movement of the fasteners 60 (i.e. they don't wobble) so that the threaded portions 69 can be aligned with their respective threaded holes on the mother board.

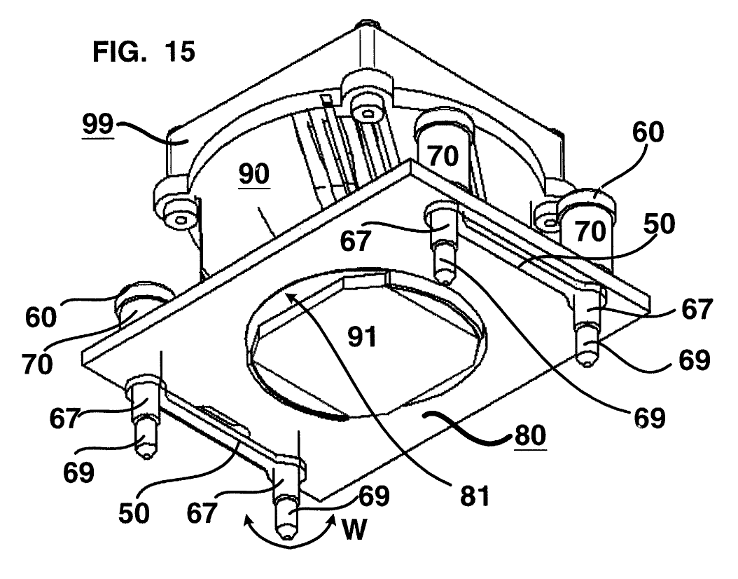

In FIG. 13, a base plate 80 having an aperture 81 therein for receiving a base portion of a heat sink (see reference numeral 91 in FIG. 15) includes several bores 33 through which the retainer assembly 10 with retainer bodies 12 connected with the spanner 50 prior to insertion into the bores 33. As was mentioned above, the spanner 50 can position the retainer bodies 12 so that their respective axes Y-Y (not shown) are substantially aligned with a central axis C-C (see FIG. 12) of the bores 33. The fasteners 60 and the springs 70 are positioned to be inserted through the bores 33 and into the chambers 20 of the retainer bodies 12.

In FIG. 14, the retainer assemblies 10 have been inserted into the bores 33 by pressing them into contact with the bores 33 until the ribs 27 deform and the retainer bodies 12 slide into their respective bores 33. The springs 70 are the fitted over their respective shanks 63 and the fasteners 60 are then inserted and retained in the retainer bodies 12 as was described above. After insertion, the fasteners are held snugly in their retainer bodies 12 so that they don't wobble as illustrated by arrow W. If the screw holes (not shown) that are to receive the threaded portions 69 have substantially the same spacing as S_{C} of FIG. 12, then the fasteners 60 will be substantially aligned with their respective screw holes because the fastener 60 don't wobble W after retention in the retainer bodies 12.

In FIG. 15, a heat sink 90 having a fan 99 mounted thereon is connected with the base plate 80 and a base portion 91 of the heat sink 90 is positioned in the aperture 81. The threaded portions 69 can be easily aligned with their respective screw holes and the base plate 80 can be mounted to the mother board such that the base portion 91 is in contact with a surface of a component to be cooled by the heat sink 90.

The retainer assembly 10 as described herein can be manufactured using a variety of methods. For instance, the retainer assembly 10 can be manufactured out of metal, an elastomer, rubber, or plastics using a process such as machining, casting, molding, and injection molding. An exemplary retainer assembly 10 was manufactured out of plastic using polycarbonate 30% glass filled material through an injection molding process.

Turning now to FIGS. 9a and 9b, exemplary dimensions in millimeters (mm) for the fastener 60 and the spring 70 include but are not limited to those set forth below.

For the fastener 60: L=35.4 mm; L₁=28.9 mm +0.1/−0.15 mm; L₂=21.9 mm; L₃=5.5 mm; L₄=1.0 mm; L₅=3.0 mm; H_{R}=8.0 mm and D_{R}=3.50 mm; D_{S}=5.0 mm +0.1/−0.0 mm; D_{SO}=4.95 mm +0.1/−0.05 mm; and D_{T} is application specific; however, a 6-32 UNC threading was used for the threaded portion 69; and a radiused portion 64 of the threaded portion 69 had a radius R_{T}=0.20 mm.

For the spring 70: a length L_{S}=16.75 mm±0.1 mm; and an inside diameter d_{S}=6.7 mm±0.15 mm.

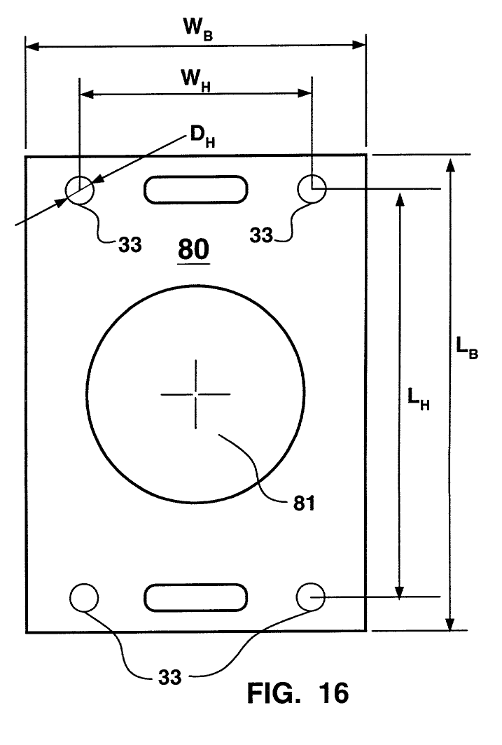

One example of an useful application of the retainer assembly 10 of the present invention is to retain a fastener or a fastener and a spring to a base plate that is connected with a cooling device such as a heat sink. In FIG. 16, an exemplary dimensions for the base plate 80 (in millimeters) include but are not limited to a length L_{B}=89 mm±0.2 mm and a width W_{B}=68.5 mm±0.2 mm. A center-to-center spacing between the bore holes 33 on the width dimension of the base plate 80 is W_{H}=38 mm±0.15 mm and on the length dimension is L_{H}=81 mm±0.15 mm. The bore holes 33 can have an inside diameter D_{H}=6.6 mm to 7.0 mm.

An exemplary retainer assembly 10 (see FIGS. 7, 8a, and 8b) can have dimensions (in millimeters) that include but are not limited to: the first inside diameter D₁=5.1 mm; the third inside diameter D₃=4.85 mm; the second inside diameter D₂ varies from 5.1 mm to 4.85 mm at the slip-over profile 21 such that at the beginning of the slip-over profile, D₂=5.1 mm and at the annular ring 23, D₂=4.85 mm; a distance between axes Y-Y of the retainer bodies 12 of S_{R}=38 mm±0.05 mm; an overall height H_{R}=8.05 mm; an overall length L_{R}=45.5 mm; a thickness T_{R}=1.8 mm; a width of the spanner 50 of W_{R}=3 mm; a diameter of the retainer bodies 12 across the ribs 27 of DR=7.43±0.1 mm; an outside diameter D=5.23 mm; and a thickness (i.e. the distance the ribs 27 extend outward of the outer wall 13) of the ribs 27=1.2 mm.

The above listed dimensions for the fastener 60, the spring 70, the base plate 80, and the retainer assembly 10 are example dimensions only and the present invention is not to be construed as being limited to those dimensions. Actual dimensions for the fastener 60, the spring 70, the base plate 80, and the retainer assembly 10 will be application dependent. Moreover, although the retainer assembly 10 has been described as being useful as a fastener retainer for a base plate, the retainer assembly 10 is not to be construed as being limited to that use only. The retainer assembly 10 can be used in any application in which retention of a fastener or a fastener in addition to other elements including a spring is desirable.

Although several embodiments of the present invention have been disclosed and illustrated, the invention is not limited to the specific forms or arrangements of parts so described and illustrated. The invention is only limited by the claims.

What is claimed is:

1. A retainer assembly for retaining a fastener including a shank with a recessed portion, comprising:
at least one retainer body including:
an outer wall having an outside diameter; and
an inner wall inset from the outer wall and symmetrically positioned about an axis and defining a chamber through the retainer body having an entrance aperture positioned opposite an exit aperture,
the inside wall including a first inside diameter extending inward of the entrance aperture along the axis and narrowing to a second inside diameter at a slip-over profile and narrowing again to a third inside diameter at an annular ring extending to the exit aperture, and
wherein the shank is inserted through the entrance aperture until the shank engages and slips over the slip-over profile and through the annular ring so that the recessed portion is captured within the annular ring thereby retaining the fastener in the chamber.

2. The retainer assembly of claim 1 wherein the retainer body is made from a material selected from the group consisting of and electrically non-conductive material, a metal, an elastomers, rubber, and plastic.

3. The retainer assembly of claim 2 wherein the electrically non-conductive material is a glass filled polycarbonate.

4. The retainer assembly of claim 1 and further comprising a flange connected with and extending outward of the outer wall and operative to prevent complete insertion of the retainer body into a bore adapted to receive the retainer body.

5. The retainer assembly of claim 1 and further comprising:
a plurality of ribs connected with the outer wall and extending outward therefrom, the ribs are adapted to deform when the retainer body is inserted into a bore adapted to receive the retainer body so that the retainer body is substantially centered in the bore and is retained therein.

6. The retainer assembly of claim 5 wherein the ribs are equidistantly spaced apart.

7. The retainer assembly of claim 5 wherein the ribs have an orientation that is colinear with the axis.

8. The retainer assembly of claim 1 and further comprising:
a spanner connected with at least two the retainer bodies and operative to spatially position the retainer bodies relative to each other.

9. The retainer assembly of claim 8 wherein the spanner positions the retainer bodies in a substantially planar orientation with each other.

10. The retainer assembly of claim 8 wherein the spanner positions the retainer bodies so that their respective axes are substantially aligned with a central axis of a bore the retainer bodies are to be inserted in.

11. The retainer assembly of claim 8 and further comprising:
a plurality of ribs connected with the outer wall and extending outward therefrom, the ribs are adapted to deform when the retainer bodies are inserted into a bore adapted to receive the retainer bodies so that the retainer bodies are substantially centered in the bore and are retained therein.

12. The retainer assembly of claim 11 wherein the ribs are equidistantly spaced apart.

13. The retainer assembly of claim 11 wherein the ribs have an orientation that is colinear with the axis.

14. The retainer assembly of claim 8 wherein the retainer body is made from a material selected from the group consisting of and electrically non-conductive material, a metal, an elastomers, rubber, and plastic.

15. The retainer assembly of claim 14 wherein the electrically non-conductive material is a glass filled polycarbonate.
